(19) United States
(12) Patent Application Publication
(10) Pub. No.: US 2019/0251296 A1
(43) Pub. Date: Aug. 15, 2019

(54) METHOD FOR TAMPER-PROOF EVALUATION OF COMPONENT PROPERTIES OF A FIELD DEVICE

(71) Applicant: Endress+Hauser Process Solutions AG, Reinach (CH)

(72) Inventors: Michael Maneval, Schopfheim (DE); Michael Mayer, Oberwil (CH); Ingomar Sotriffer, Gundelfingen (DE)

(21) Appl. No.: 16/337,778

(22) PCT Filed: Aug. 28, 2017
(86) PCT No.: PCT/EP2017/071538

§ 371 Date: Mar. 28, 2019

(30) Foreign Application Priority Data
Sep. 30, 2016 (DE) 10 2016 118 615.5

(51) Int. Cl. G06F 21/64; H04L 9/32

(52) U.S. Cl. CPC G06F 21/645; H04L 2209/38; H04L 9/3239

(57) ABSTRACT

The invention relates to a method for tamper-proof evaluation of a component property of a field device, the method including the creation of an evaluation relating to the component property. The evaluation assigns each component property an applicable label or a non-applicable label. The method also includes the transmission of the created evaluation to a first service platform and storage in the first service platform. The first service platform is operated in a decentralised manner using a Distributed Ledger or Blockchain technology and consisting of a plurality of subscriber nodes, which each comprise at least one data bank. The method further includes the creation of data blocks by the subscriber nodes, where a data block links an evaluation with a field device type of an evaluated field device, whereby a plurality of evaluations of different field devices is contained in the plurality of subscriber nodes.

The invention relates to a method for tamper-proof evaluation of at least one component property of at least one field device in a facility operating by means of automation technology.

Field devices that are used in industrial facilities are already known from the prior art. Field devices are often used in process automation, as well as in manufacturing automation. Field devices, in general, refer to all devices which are process-oriented and which supply or process process-relevant information. Field devices are thus used for detecting and/or influencing process variables. Measuring devices, or sensors, are used for detecting process variables. These are used, for example, for pressure and temperature measurement, conductivity measurement, flow measurement, pH measurement, fill-level measurement, etc., and detect the corresponding process variables of pressure, temperature, conductivity, pH value, fill-level, flow, etc. Actuators are used for influencing process variables. These are, for example, pumps or valves that can influence the flow of a fluid in a pipe or the fill-level in a tank. In addition to the aforementioned measuring devices and actuators, field devices are also understood to include remote I/O's, radio adapters, or, generally, devices that are arranged at the field level.

A variety of such field devices is produced and marketed by the Endress+Hauser group.

In modern industrial facilities, field devices are usually connected via communications networks, such as fieldbuses (Profibus®, Foundation® Fieldbus, HART®, etc.), to higher-level units. Usually, the superordinate units are control units, e.g., an SPC (storage programmable control) or a PLC (programmable logic controller). The higher-level units are used for, among other things, process control, as well as for commissioning of the field devices. The measured values detected by the field devices—in particular, by sensors—are transmitted via the respective bus system to a (or possibly several) higher-level unit(s) that further process the measured values, as appropriate, and relay them to the control station of the plant. The control station serves for process visualization, process monitoring, and process control via the superordinate units. In addition, a data transfer is also required from the higher-level unit via the bus system to the field devices—in particular, for configuration and parameterization of field devices, as well as for control of actuators.

Field devices, or components of field devices, must, in use, satisfy a wide variety of requirements, depending upon the application. Depending upon the particular application, the components must have, for example, EMC, SIL, and/or explosion-protection properties.

In practice, these requirements are certified by tests in laboratories. In this, historical empirical values for a component property are set as the norm. If the component property of the field device meets this norm, the field device is certified accordingly. Further component properties are, for example, whether the device is gauged, whether the device is calibrated, waterproofness, and/or chemical resistance.

A disadvantage of this procedure is that suitable infrastructures, such as test laboratories, are often needed for said tests, and this is associated with great expense. The tests certify the applicability of a component property under laboratory conditions; real environmental conditions are only inadequately represented under certain circumstances. Customers, i.e., potential purchasers of the field devices, often rely on so-called in-service experience. This means that component properties were perceived as applicable in the customers own application at their facility under the environmental conditions prevailing there, which cannot be replicated in the tests by test laboratories. Furthermore, certificates are frequently issued only regionally and from a single test location. Uniform, global certificates have so far only rarely been established.

On the basis of this problem, the aim of the invention is to present a method which allows evaluations of component properties in the real use of a field device in a tamper-proof manner.

The aim is achieved by a method of tamper-proof evaluation of at least one component property of at least one field device in an automation facility, comprising:
creation of an evaluation relating to the component property of the field device by at least one facility operator, wherein the evaluation assigns each component property an applicable or a non-applicable label; and
transmission of the created evaluation to a first service platform and storage of the created evaluation in the first service platform, wherein the first service platform is operated in a decentralized manner with the aid of a distributed ledger or blockchain technology and consists of a plurality of subscriber nodes, wherein the subscriber nodes each have at least one data bank, and
generation of data blocks by the subscriber nodes, wherein a data block contains at least one evaluation linked with the field device type of an evaluated field device, whereby a plurality of evaluations of different field devices—preferably from several facility operators—is contained in the plurality of subscriber nodes.

The great advantage of the method according to the invention is that a large reservoir of experience relating to component properties of a large number of different field devices is stored and is available in data blocks in a tamper-proof manner by means of a service platform which operates on the principle of blockchain technology. A data block has a data field with transactions and a so-called hash value. A transaction contains information relating to the sender and the recipient of the transaction, as well as the evaluation of the component properties, linked with the field device type of a field device. The data field of a data block contains all transactions generated after the point in time that the last data block was created. These ratings are converted via an algorithm into an intermediate value; for example, the “Merkle root” of all transactions contained in the data field of the data block is calculated. The hash value of the data block is generated from this intermediate value and the hash value of the preceding data block. A string of several data blocks is referred to as blockchain. By calculating the evaluations stored in a data block to a hash value, these evaluations cannot be changed/manipulated without changing the hash value of the data block, and thus the respective hash values of all subsequent data blocks.

Different facility operators thus detect component properties and indicate whether the respective property applies at their facility—for example, whether or not a field device is EMC-proof in their particular facility. The evaluations originate from the real use of a field device, whereby the multitude of evaluations produces a representative statement as to whether a component property generally applies or not. This information is stored in data blocks, which in turn are stored in the subscriber nodes of the first service platform—more precisely, in data banks of the subscriber nodes.

The subscriber nodes of the first service platform are formed by computing units. The various subscriber nodes are connected to each other via a network—for example, via the Internet. The facility operator contacts one of the subscriber nodes of the first service platform and transmits to it the data to be stored, i.e., the evaluation relating to the component properties of a field device. The subscriber node then creates a so-called transaction and transmits this transaction to all other subscriber nodes—if necessary, for validation. The subscriber node then creates a new data block which contains the transaction and, possibly, further transactions.

In the process, it is provided that the same data blocks, i.e., the identical evaluations, be stored and available on all data banks at all times. If one or more data banks are missing or are tampered with by an attacker, the information can be read out from the remaining data banks, as a result of which complete data loss is virtually impossible. Examples of such a service platform are, for example, Etherium or Blockstream.

Field devices that are mentioned in connection with the method according to the invention are already described by way of example in the introductory part of the description.

According to an advantageous embodiment of the method according to the invention, it is provided that the following method steps additionally be carried out:
access to the first service platform by a client using a client PC;
selection of a field device type; and
creation and display of an overall evaluation of the selected field device type, wherein the overall evaluation contains all evaluations of the field device type, its at least one component property, and the number of the respective applicable label or non-applicable label of the at least one component property.

A customer, i.e., a potential buyer of a field device, can thus inform himself before the purchase about which component properties in how many cases have turned up with facility operators, or in how many cases they have not. A customer therefore receives a neutral, independent statement, supported by the experience of many facility operators who were able to “experience” or test the component properties in real use.

In a preferred development of the method according to the invention, it is provided that, during the selection of the field device type, the customer input data relating to an application in which the field device is to be installed in a facility. In the data relating to an application, features are denoted that describe a field device in its customer application to be used. These features represent, for example, the type of facility (food industry, chemical transport, wastewater industry, etc.) in which the field device is to be operated, the climate zone in which the facility is located, the infrastructure of the facility (fieldbuses, power supply, explosion-protected areas), the quality of supply resources for the field devices/facility (electrical power, water, etc.), the customers experience/know-how relating to the respective field device type, etc.

In accordance with a preferred further development of the method according to the invention, it is provided that, during the creation of an evaluation of the field device, the facility operator provide data about an application in which the field device is installed in a facility. In the data relating to an application, features are denoted that describe a field device in its used application of the facility operator. These features represent, for example, the type of facility (food industry, chemical transport, wastewater industry, etc.) in which the field device is operated, the climate zone in which the facility is located, the infrastructure of the facility (fieldbuses, power supply, explosion-protected areas), the quality of supply resources for the field devices/the facility (electrical power, water, etc.), the experience/know-how of the facility operator relating to the respective field device type, etc.

In accordance with a particularly preferred development of the method according to the invention, it is provided that, during the creation of the overall evaluation, only those evaluations of a field device type be taken into account in which the application data of the customer agree with the application data of the facility operator or the facility operators. In this way, the customer can view the evaluations of those field devices which have the desired field device type and are, additionally, implemented in a similar application. The customer can thereby predict how likely component properties of a field device type are to apply to his application intended for a field device of this field device type, and, as a result, can make an informed purchase decision.

A preferred embodiment of the method according to the invention provides that the facility operator or the facility operators be anonymized during the creation of the evaluation, so that the evaluation does not allow any conclusion to be drawn about the facility operator. As a result, the inhibition threshold for submitting a component evaluation is lowered for a facility operator.

According to a particularly advantageous embodiment of the method according to the invention, a created data block is verified by all subscriber nodes and is only stored in the first service platform when at least a predetermined number of all subscriber nodes successfully verifies the data block. The data block is validated in such a way that its hash value is checked. Only if the valid hash value of the previous data block is used, can the data block be successfully validated. As a result, data cannot be modified in a successfully-validated data block without changing the subsequent data blocks accordingly. A modification of data produces a changed intermediate value, thereby also changing the hash value of the respective data block. The subsequent data block thus no longer matches its previous data block. Data of a once successfully-validated data block can therefore no longer be modified by an attacker.

According to a preferred embodiment of the method according to the invention, the created evaluation is transmitted to all subscriber nodes and is validated by the subscriber nodes before processing into the data block, and the created evaluation is stored in the data block only if it is successfully validated by at least one of the subscriber nodes. There is, in particular, a check as to whether the originator of the transaction is a valid subscriber node, or that the data contained in the transaction are, for example, within a valid value range.

According to an advantageous further development of the method according to the invention, it is provided that the field device be integrated as a subscriber node in the first service platform and be configured to create data blocks. However, this requires that the field device, if necessary, be supplied with sufficient power and energy, possibly by means of an additional power supply, because complex algorithms are executed for the creation of a data block.

Furthermore, the field device can be designed to create transactions. In contrast to the creation of a data block, the creation of a transaction requires significantly less power, so that the field device does not have to have an additional power supply for a possible creation of transactions, and may even be supplied with power via the communications network.

In this case, it can be provided that the algorithms required for creating the transactions and/or the data blocks, or the security data blocks, be integrated in the electronics unit of the field device or that the field device have a modular additional electronics unit—in particular, a plug-in module—in which these algorithms are implemented. The algorithms/software instructions required for this purpose can accordingly be loaded in the form of, for example, a firmware update onto a writable memory in the electronics unit or the additional electronics unit.

The invention is explained in greater detail with reference to the following figures. Shown are:

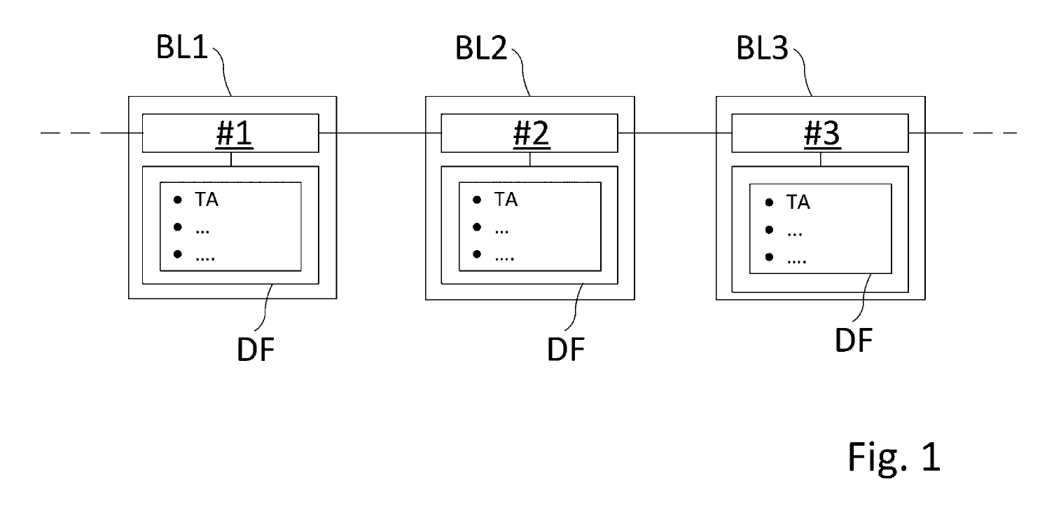

FIG. 1: an explanation of data blocks, which are employed in the method according to the invention; and

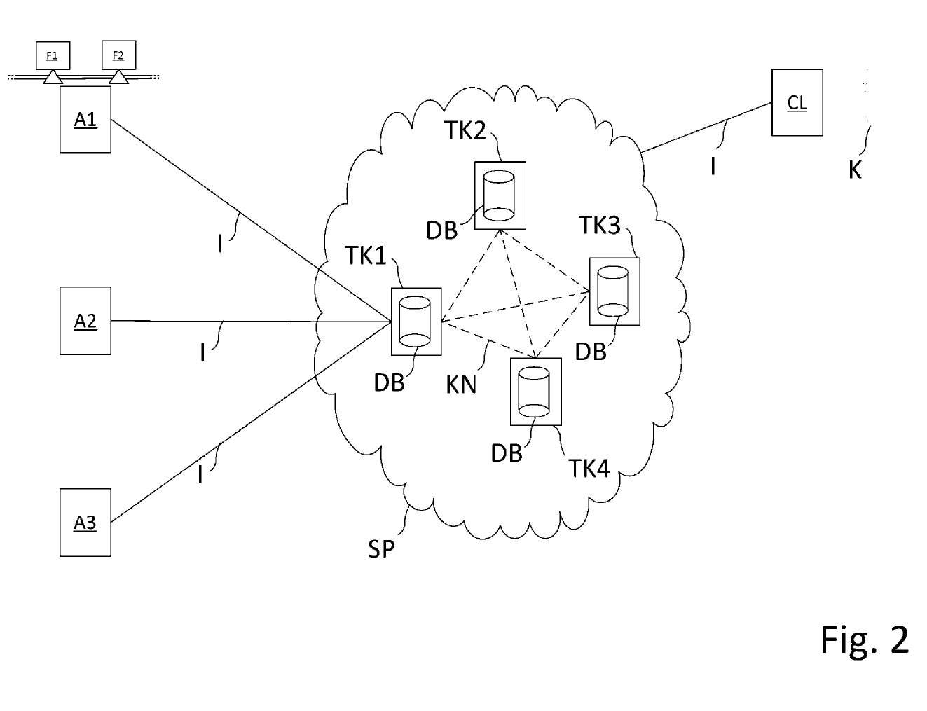

FIG. 2: an embodiment of the method according to the invention.

FIG. 1 shows an explanation of data blocks BL1, BL2, BL3 which are designed according to the blockchain technology. The blockchain technology became known as the backbone of the Internet currency, “Bitcoin.” A blockchain, i.e., a chain of linked data blocks BL1, BL2, BL3, allows high data integrity. The operation of a blockchain designed for the method according to the invention will be briefly explained below.

As a rule, a said data block BL1, BL2, BL3 is made up of at least two components; for one, this is a data field DF. Data in the form of transactions TA are stored in this data field DF. Transaction TA denotes a transmission of the data from a first subscriber node TK to a second subscriber node TK in a communications network KN. A transaction TA contains a transmitted value—in this case, therefore, data—as well as the transmitter and the recipient of the transaction TA. Subscriber nodes TK refer to all devices which use the blockchain technology in the communications network KN.

A data field DF of a data block BL1, BL2, BL3 contains at least one transaction TA, and, more frequently, several transactions TA.

For another, a data block BL1, BL2, BL3 contains a checksum #1, #2, #3. Such a checksum #1, #2, #3 is a hash value and is created by sometimes complex calculations. For this purpose, all transactions TA of the data field of a block BL1, BL2, BL3 are calculated to an intermediate value. For example, the Merkle root of the total number of transactions TA is calculated for this. The exact functional principle shall not be discussed at this point. For this, reference is made, for example, to https://en.wikipedia.orgiwiki/Merkle_tree.

This calculated intermediate value is then converted with the checksum #1, #2, #3 of the previous data block BL1, BL2, BL3 to the checksum #1, #2, #3 of the current data block BL1, BL2, BL3. For example, the data block BL2 shown in FIG. 1 contains a checksum #2. This checksum #2 was thus calculated from the transactions TA stored in the data field DF of the data block B2 and the checksum #1 of the preceding data block BL1. Analogously, the data block BL3 shown in FIG. 1 contains a checksum #3. This checksum #3 was thus calculated from the transactions TA stored in the data field DF of the data block B3 and the checksum #2 of the preceding data block BL2.

The integrity of the data, i.e., the protection of the data against subsequent tampering, is thus ensured by storing the checksum #1, #2, #3 of the preceding data block BL1, BL2 in the respective subsequent data block BL2, BL3. A blockchain is thus made up of a series of data blocks BL1, BL2, BL3, in each of which one or more transactions TA are combined and provided with the checksum #1, #2, #3. A modification of data produces a modified intermediate value, thereby also modifying the checksum #1, #2, #3 of the respective data block BL1, BL2, BL3. The subsequent data block BL1, BL2, BL3 thus no longer matches the preceding data block BL1, BL2, BL3. As a result, data of a once successfully-validated data block BL1, BL2, BL3 can no longer be modified by an attacker.

New data blocks BL1, BL2, BL3 are created at regular intervals. All transactions TA which were created after the point in time at which the last data block BL1, BL2, BL3 was created are stored in the data field of the new data block BL1, BL2, BL3.

The complexity of the block creation can be increased due to the fact that the established checksum #1, #2, #3 must have a predefined format. For example, it is determined that the checksum must be 24 characters long, wherein the first four characters must have the numerical value 0. For this purpose, in addition to the intermediate value of the transactions TA and the checksum of the previous data block, a numerical sequence to be determined, called a “nonce” and having a fixed length, is used for calculating the checksum #1, #2, #3 of the current data block BL1, BL2, BL3. The calculation of the new checksum #1, #2, #3 takes correspondingly longer, since only a few nonces are present which result in the calculation of a checksum #1, #2, #3 with the predetermined criteria. Finding such a suitable nonce in this case causes the described additional time expenditure.

After the checksum #1, #2, #3 of a new data block BL1, BL2, BL3 has been created, the data block is transmitted to all subscriber nodes TK. The subscriber nodes TK now check the checksum #1, #2, #3 of the new data block BL1, BL2, BL3. Only after successful validation is the data block BL1, BL2, BL3 stored in all subscriber nodes TK. In particular, successful validation of more than half of all subscriber nodes TK is required for this purpose. In order to load/create a foreign, harmful data block BL1, BL2, BL3, an attacker would therefore have to tamper with or check a large number of subscriber nodes TK in order to successfully validate the loaded data block BL1, BL2, BL3. With an increasing number of subscriber nodes TK, this is to be considered as good as impossible.

For the validation of a data block BL1, BL2, BL3, a substantially lower effort is needed than for creating the data block BL1, BL2, BL3. The checksum #1, #2, #3 is back-calculated, and the intermediate value of the transactions TA or the checksum #1, #2, #3 of the previous data block BL1, BL2, BL3 is recovered and compared to the actual intermediate value or to the actual checksum #1, #2, #3 of the previous data block BL1, BL2, BL3. If these values match, the data block BL1, BL2, BL3 is successfully validated.

In the following, it is described how component properties of a field device F1, F2 can be evaluated using blockchain technology and, as a result, a reservoir of experience can be built up relating to the component properties of the field devices F1, F2:

FIG. 2 shows an embodiment of the method according to the invention. Several facilities A1, A2, A3 of the process automation are depicted. Each of the tools A1, A2, A3 has at least one field device F1, F2 (for reasons of clarity, only the field devices F1, F2 of the facility A1 are depicted). The field devices F1, F2 are, for example, pressure-measuring devices which are operated with a high electromagnetic noise factor in a power plant.

Due to these environmental conditions, the field devices F1, F2 must have good EMC protection. In the course of time, the facility operator of the facility A1 notices that the field device F2 outputs measured values with noise signals that are apparently caused by the electromagnetic radiation within the facility A1. The field device F1 does not display these noise signals. The two field devices are different field device types which differ, inter alia, in the housing, by which differences in EMC compatibility can be explained.

In the case of the housing of the field device F1, the component property, “EMC protection,” applies; in the case of the field device F2, it does not.

The facility operator of the facility A1 enters this experience as an evaluation into a first service platform SP. For this purpose, it connects, e.g., with a client PC, to the first service platform SP—preferably with a subscriber node TK1, TK2, TK3, TK4 of the first service platform—via the Internet I. After successful connection, it enters the field device type of the field devices F1, F2, as well as the applicable label or a non-applicable label of the component property, “EMC protection,” connected to the data relating to the application of the respective field devices F1, F2. A particular feature of the data relating to the application in this case is that there is a high degree of electromagnetic radiation in the system A1.

After receiving the evaluations, a subscriber node TK1, TK2, TK3, TK4 of the service platform creates one or more transactions TA which contain the evaluations linked with the field device type and the respective data relating to the respective applications of the field devices F1, F2. After validation of the transactions TA by all subscriber nodes TK1, TK2, TK3, TK4, a block is created as described in FIG. 1, and any additional steps described in FIG. 1 are executed.

Over time, a large reservoir of experience relating to component properties of different field device types is formed by evaluations of further component properties of the field devices F1, F2, as well as the field devices from other facilities A2, A3.

A customer K, who requires a purchase decision for a new field device for an application in his facility, connects to the first service platform SP via the Internet I by means of his client PC CL. There, he selects his desired field device type and then receives an overall evaluation of the selected field device type, wherein the overall evaluation contains all evaluations of the field device type, its at least one component property, and the number of the respective applicable labels or non-applicable labels of the at least one component property. In this way, it is readily apparent to a customer whether a specific field device type offers a desired component property or not.

By entering data relating to the new application in his own facility, the customer K receives a filtered overall evaluation which indicates all field devices of the selected field device type in which the application data of the customer K agree with the application data of the facility operator or the facility operators. In this way, the customer immediately learns whether or not a field device type offers the desired component properties for his specific application.

The facility operators can be anonymized if desired, so that no conclusions can be drawn about the respective facility operator from the entered evaluations. The inhibition threshold for a facility operator to output a component evaluation can thereby decrease.

It goes without saying that the exemplary embodiments shown are only exemplary in nature, and the method according to the invention can be carried out with any type and arrangement of field devices in a process automation facility.

### LIST OF REFERENCE SYMBOLS

A1, A2, A3 Process automation facility
BL1, BL2, BL3 Data block
CL Client PC of the customer
DB Data bank
DF Data field
F1, F2 Field device
I Internet
K Customer
KN Communications network
SP Service platform
TA Transaction
TK1, TK2, TK3, TK4 Subscriber nodes
#1, #2, #3 Hash values of the data blocks

1-9. (canceled)

10. A method for tamper-proof evaluation of a component property of a field device in a facility operating using automation technology, the method including:
creating an evaluation relating to the component property of the field device, wherein the evaluation assigns each component property an applicable label or a non-applicable label;
transmitting the evaluation to a first service platform;
storing the evaluation in the first service platform;
wherein the first service platform is operated in a decentralized manner using a distributed ledger or blockchain technology and includes a plurality of subscriber nodes, wherein the subscriber nodes each have at least one data bank; and
creating data blocks using the subscriber nodes, wherein a data block contains at least one evaluation linked with a field device type of an evaluated field device, wherein a plurality of evaluations of different field devices are contained in the plurality of subscriber nodes.

11. The method of claim 10, further including:
accessing the first service platform by a client using a client PC;
selecting the field device type;
creating an overall evaluation of the selected field device type; and
displaying the overall evaluation;
wherein the overall evaluation includes all evaluations of the field device type, at least one corresponding component property, and a number of the respective applicable label or non-applicable label of the at least one component property.

12. The method of claim 11, wherein selecting the field device type includes entering data relating to an application in which the field device is to be installed in a facility.

13. The method of claim 11, wherein creating the evaluation includes providing data relating to an application in which the field device is to be installed in a system.

14. The method according to claim 13, wherein creating the overall evaluation includes taking into account only those evaluations of the field device type in which application data of a customer match application data of a facility operator.

15. The method of claim 10, wherein facility operators are anonymized during the creation of the evaluation.

16. The method of claim 10, wherein a created data block is verified by all subscriber nodes and is stored in the first service platform only if at least a predetermined number of all subscriber nodes successfully verifies the data block.

17. The method of claim 10, wherein the evaluation is transmitted to all subscriber nodes before the processing into the data block and is validated by the subscriber nodes, and wherein the evaluation is stored in the data block only if it is successfully validated by at least one of the subscriber nodes.

18. The method of claim 10, wherein the field device is integrated as subscriber nodes in the first service platform and is configured to create data blocks.
